(19) United States
(12) Patent Application Publication
(10) Pub. No.: US 2018/0031271 A1
(43) Pub. Date: Feb. 1, 2018

(54) PTC LIQUID HEATER

(71) Applicant: BESTWAY INFLATABLES & MATERIALS CORP., Shanghai (CN)

(72) Inventors: Shuiyong HUANG, Shanghai (CN); Jiang XU, Shanghai (CN); Guoping LI, Shanghai (CN)

(21) Appl. No.: 15/478,863

(22) Filed: Apr. 4, 2017

(30) Foreign Application Priority Data
Jul. 28, 2016 (CN) 201620805310.5

(51) Int. Cl. F24H 1/10; H05B 1/02

(52) U.S. Cl. CPC F24H 1/102; H05B 1/0297

(57) ABSTRACT

A PTC (Positive Temperature Coefficient) liquid heater, comprising: a heating assembly, comprising: a heat conductor having at least one accommodating cavity, a PTC heat generation assembly disposed in the at least one accommodating cavity, a sheath having a cavity for accommodating the heat conductor and the PTC heat generation assembly, and a housing having a water inlet and a water outlet, wherein the heating assembly at least partially passes through the housing. The PTC liquid heater of the present invention has a better corrosion resistance, and can greatly extend the service life of the liquid PTC heater and prevent electric leakage accidents. The PTC liquid heater has a simple structure and low costs, and is convenient to assemble, especially in that the water pipes can replaced, facilitating future maintenance.

### CROSS REFERENCE

This application claims the benefit and priority of Chinese Application No. 201620805310.5, filed Jul. 28, 2016. The entire disclosures of each of the above applications are incorporated herein by reference.

### FIELD OF THE INVENTION

The present invention relates to a heater, particularly to a PTC liquid heater.

### BACKGROUND

Currently, PTC (Positive Temperature Coefficient) livid heaters have been widely applied in household appliances, such as SPA pools, entertainment pools, water dispensers, foot baths, and other industrial products.

One type of common PTC heaters in the prior art comprises a heat conductor and a PTC heating element. A plurality of ducts are provided within the heat conductor, some of the ducts being used for placing PTC heating elements while some of the ducts being used for liquid passage. The heat conductors of some of the PTC heaters employ metal materials without an anti-corrosion treatment, which are prone to corrosion after long-term use.

If chemical substances such as oxidizing disinfectants are contained in water, the oxidation and corrosion of the heat conductor will be accelerated, easily leading to the leakage of liquid from the ducts inside the heat conductor, and increasing safety risks.

### SUMMARY

A technical problem to be solved by the present invention is to provide a PTC liquid heater in order to overcome the defect that the PTC heaters in the prior art are prone to corrosion during long-term use.

The above-mentioned technical problems are solved in the present invention by the following technical solution:

A PTC (Positive Temperature Coefficient) liquid heater can be provided comprising a heating assembly and a housing. The heating assembly can include a heat conductor having at least one accommodating cavity, a PTC heat generation assembly disposed in the at least one accommodating cavity, a sheath having a cavity for accommodating the heat conductor and the PTC heat generation assembly. The housing can have a water inlet and a water outlet. The heating assembly at least partially passes through the housing.

In some embodiments, the heat conductor can be configured in a cylindrical shape, and the at least one accommodating cavity being configured in the heat conductor in an axial direction of the cylinder.

In some embodiments, the sheath can comprise a penetrating sleeve, the heat conductor and the PTC heat generation assembly being disposed in the sleeve, and an inner surface of the sleeve abuts against an outer surface of a side wall of the heat conductor.

In some embodiments, the sheath can comprise a sleeve end cover that is disposed at one end of the sleeve, and an edge of the sleeve end cover is connected to an edge of an end portion of the sleeve.

In some embodiments, the sheath can comprise a flange that is connected to an outer surface of one end of the sleeve and extend outwardly.

In some embodiments, the sleeve can be configured as a straight, round tube.

In some embodiments, the sleeve and the sleeve end cover can be made of corrosion-resistant heat-conducting material.

In some embodiments, the housing can comprise a main body, a first end cover and a second end cover. The main body can have a tubular cavity, allowing a fluid to flow through the tubular cavity. The first end cover can be connected to a first end of the main body, and at least one first through hole is arranged on the first end cover. The second end cover can be connected to a second end of the main body, and at least one second through hole is arranged on the second end cover. The heating assembly can pass through the first and second through holes.

In some embodiments, the first end cover can be detachably connected to the first end of the main body, and the second end cover can be detachably connected to the second end of the main body.

In some embodiments, the first end cover can be integrally formed with the main body, and the second end cover can be detachably connected to the second end of the main body.

In some embodiments, the first and second through holes can be configured in round shape.

In some embodiments, the housing can further comprise first seals that are disposed at the first through hole of the first end cover and the second through hole of the second end cover, respectively.

In some embodiments, the housing can further comprise a second seal that is disposed at an opening of the first end of the main body of the housing.

In some embodiments, the housing can further comprise a second seal that is disposed at an opening of the second end of the main body of the housing.

In some embodiments, the housing can further comprise a first fixing member and a second fixing member. The first fixing member can be connected to the first end cover, and the first fixing member comprising at least one third through hole can be arranged on the first fixing member. The second fixing member can be connected to the second end cover, and the second fixing member comprising at least one fourth through hole can be arranged on the second fixing member. And the heating assembly can pass through the third and fourth through holes.

In some embodiments, the first seals can be disposed between the first end cover and the first fixing member, and can be disposed between the second end cover and the second fixing member, respectively.

In some embodiments, the third and fourth through holes can be configured in round. shape.

In some embodiments, the flange of the sheath of the heating assembly can be sandwiched between the first seal at the second end of the main body of the housing and the second fixing member.

In some embodiments, the housing can further comprise at least one partition plate that is disposed in the cavity of the main body in the longitudinal direction of the tubular cavity. Two opposite first ends of the partition plate can be connected to two opposite first side walls of the main body, and at least one of two opposite second ends of the partition plate can be connected to at least one of the first and second end covers. And the sleeves can be disposed on two sides of the partition plate. And the length of the partition plate being less than that of the tubular cavity.

In some embodiments, at least one partition plate disposed in the tubular cavity in the longitudinal direction, two opposite first ends of the partition plate being connected to two opposite first side walls of the main body, two opposite second ends of the partition plate being connected to the first cover and second end cover, and at least one fifth through hole is arranged on, the partition plate.

In some embodiments, the water inlet and the water outlet can be formed on the main portion of the housing.

In some embodiments, the housing can comprise a main body and a first end cover. The main body can have a box-shaped cavity and an opening, and the main body can comprise a water inlet and a water outlet. The first end cover can be connected to both the opening portion of the main body and the heating assembly. And the heating assembly can be at least partially disposed in the cavity of the main body.

In some embodiments, the sheath of the heating assembly can be connected to the first end cover.

In some embodiments, a flange of the sheath can be connected to the first end cover.

In some embodiments, the first end cover can have a first through hole, and the heating assembly may pass through the first through hole.

In some embodiments, the housing can further comprise a second seal, which is disposed between an end portion of the opening of the main body and the first end cover.

In some embodiments, the housing can comprise a main body that has a box-shaped cavity and an opening, and the main body can have a water inlet and a water outlet. The heating assembly can be connected to an end portion of the opening of the main body. And the heating assembly is at least partially disposed in the cavity of the main body.

In some embodiments, the flange of the sheath of the heating assembly can be connected to the end portion of the opening of the main body.

In some embodiments, the housing can further comprise a second seal, which is disposed between a surface on one side of the flange of the sheath and an end face of the opening of the main body.

In some embodiments, the housing is made of plastic.

The positive progressive effects of the present invention lie in:

The PTC liquid heater of the present invention has a better corrosion resistance, and can greatly extend the service life of the liquid PTC heater and prevent electric leakage accidents. The PTC liquid heater has a simple structure and low costs, and is convenient to assemble, especially in that the water pipes can be replaced, facilitating future maintenance.

### BRIEF DESCRIPTION OF THE DRAWINGS

The above-mentioned and other features, characteristics and advantages of the present invention will be more apparent from the following description taken in conjunction with the accompanying drawings and embodiments, and in the accompanying drawings, like reference numbers indicate like features, in which:

FIG. 1 is a first overall structural schematic view of a first embodiment of a PTC liquid heater of the present invention.

FIG. 2 is a second overall structural schematic view of the first embodiment of the PTC liquid heater of the present invention.

FIG. 3 is a third overall structural schematic view of the first embodiment of the PTC liquid heater of the present invention.

FIG. 4 is a sectional view of the first embodiment of the PTC liquid heater of the present invention, which is taken in the longitudinal direction.

FIG. 5 is a first exploded view of the first embodiment of the PTC liquid heater of the present invention.

FIG. 6 is a second exploded view of the first embodiment of the PTC liquid heater of the present invention.

FIG. 7 is an exploded schematic view of a heating assembly in the first embodiment of the PTC liquid heater of the present invention.

FIG. 8 is a first overall structural schematic view of a second embodiment of a PTC liquid heater of the present invention.

FIG. 9 is a second overall structural schematic view of the second embodiment of the PTC liquid heater of the present invention.

FIG. 10 is a sectional view of the second embodiment of the PTC liquid heater of the present invention, which is taken in the longitudinal direction.

FIG. 11 is a first exploded view of the second embodiment of the PTC liquid heater of the present invention.

FIG. 12 is a second exploded view of the second embodiment of the PTC liquid heater of the present invention.

FIG. 13 is an exploded schematic view of a heating assembly in the second embodiment of the PTC liquid heater of the present invention.

FIG. 14 is an exploded view of the third embodiment of the PTC liquid heater of the present invention.

### DETAILED DESCRIPTION

To make the above-mentioned object, features and advantages of the present invention apparent, and easily understood, a detailed description of particular embodiments of the present invention is made in conjunction with the drawings.

Embodiments of the present invention will now be described in detail with reference to the accompanying drawings. Reference now be made in detail to preferred embodiments of the present invention, examples of which are illustrated in the accompanying drawings. The same reference numerals in all the figures denote the same or similar parts wherever possible. Furthermore, although the terms used in the present invention are selected from well-known common terms, some of the terms mentioned in the description of the present invention may be selected by the applicant according to his or her judgement, and the detailed meaning thereof is described in the relevant section described herein. Furthermore, the present invention must be understood, not simply by the actual terms used but also by the meanings encompassed by each term.

### First Embodiment

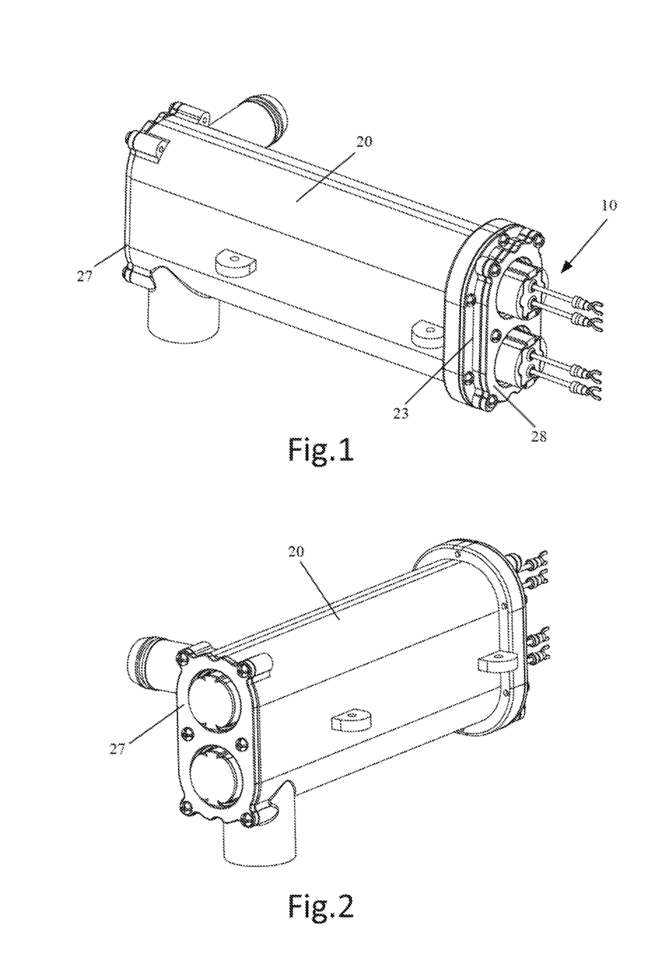

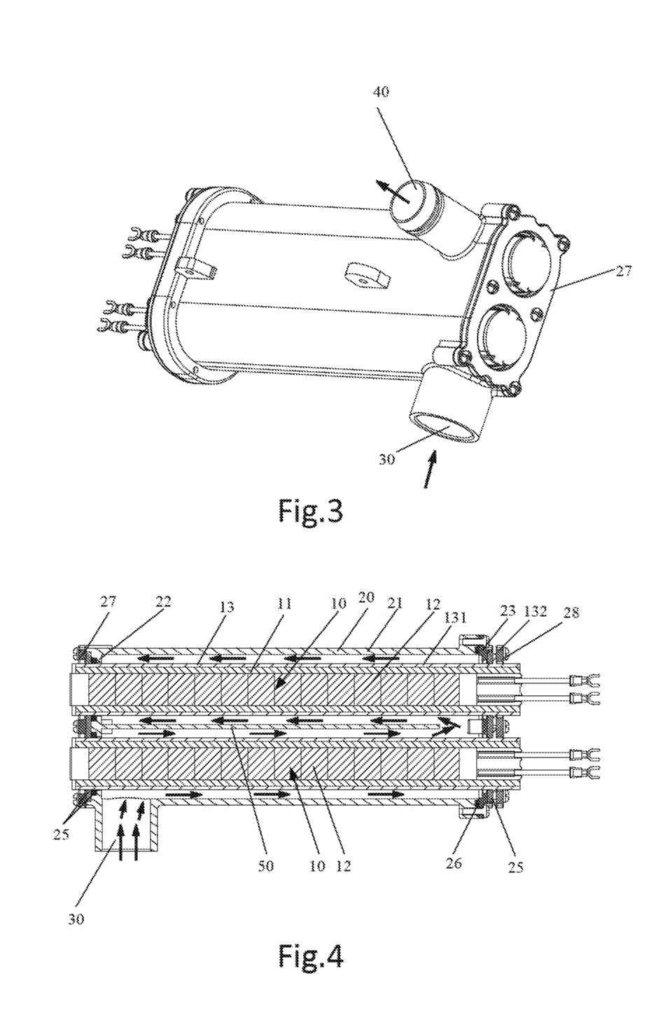

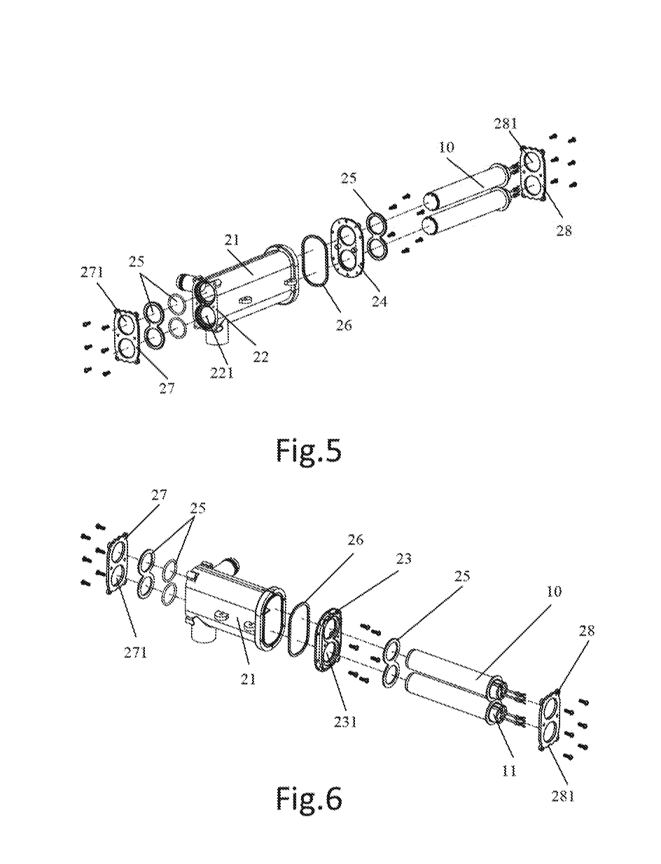

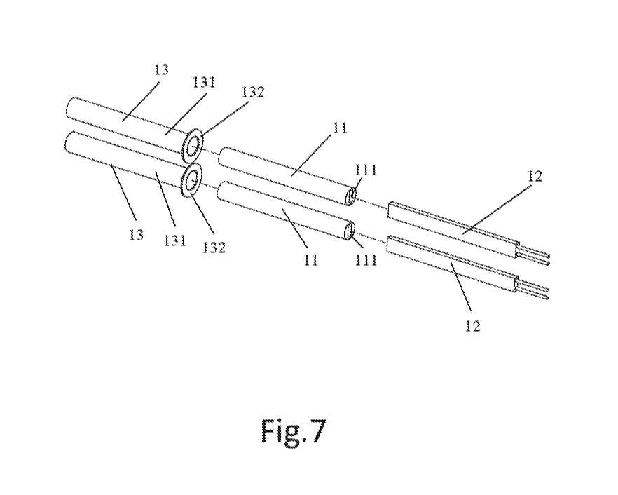

FIG. 1 is a first overall structural schematic view of a first embodiment of a PTC liquid heater of the present invention. FIG. 2 is a second overall structural schematic view of the first embodiment of the PTC liquid heater of the present invention. FIG. 3 is a third overall structural schematic view of the first embodiment of the PTC liquid heater of the present invention. FIG. 4 is a sectional view of the first embodiment of the PTC liquid heater of the present invention, which is taken in the longitudinal direction. FIG. 5 is a first exploded view of the first embodiment of the PTC liquid heater of the present invention. FIG. 6 is a second exploded view of the first embodiment of the PTC liquid heater of the present invention. FIG. 7 is an exploded schematic view of a heating assembly in the first embodiment of the PTC liquid heater of the present invention.

As shown in FIGS. 1-7, the present invention discloses a PTC liquid heater, which can include a heating assembly 10 and a housing 20. The heating assembly 10 can include a heat conductor 11, a PTC heat generation assembly 12 and a sheath 13, at least one accommodating cavity 111 can be provided in the heat conductor 11, the PTC heat generation assembly 12 can be at least partially disposed in the at least one accommodating cavity 111, and the sheath 13 can be provided with a cavity for accommodating the heat conductor 11 and the PTC heat generation assembly 12. In addition, a water inlet 30 and a water outlet 40 can be disposed on the housing 20.

The heat conductor 11 can be in the shape of a cylinder, and the at least one accommodating cavity 111 can be disposed in the heat conductor 11 in an axial direction of the cylinder.

The sheath 13 can include a penetrating sleeve 131, and the beat conductor 11 and the PTC heat generation assembly 12 can be disposed in the sleeve 131 such that an inner surface of the sleeve 131 abuts against an outer surface of a side wall of the heat conductor 11. The sheath 13 also can comprise a sleeve end cover, which is disposed at one end of the sleeve 131, such that an edge of the sleeve end cover can be connected to an edge of an end portion of the sleeve 131. The sheath 13 can also comprise a flange 132, the flange 132 is connected to an outer surface of one end of the sleeve 131 and extends outwardly. The sleeve 131 herein may be a straight, round tube, and the material of the sleeve 131 and the sleeve end cover can be made of corrosion-resistant heat-conducting material, such as stainless steel or stainless iron.

The housing 20 can include a main body 21, a first end cover 22 and a second end cover 23, and the main body 21 can be provided with a tubular cavity, which allows a fluid to flow through. The first end cover 22 can be connected to a first end of the main body 21, and the first end cover 22 can be provided with at least one first through hole 221. The second end cover 23 can be connected to a second end of the main body 21, and the second end cover 23 can be provided with at least one second through hole 231. The heating assembly 10 can pass through the first through hole 221 and the second through hole 231. The first through hole 221 and the second through hole 231 herein can be round. The water inlet 30 and the water outlet 40 can be disposed on the main body 21 of the housing 20. The heating assembly 10 can at least partially pass through the housing 20.

The first end cover 22 herein can be disposed to be detachably connected to the first end of the main body 21, and the second end cover 23 can be likewise disposed to be detachably connected to the second end of the main body 21. Alternatively, the first end cover 22 can be disposed to be integrally formed with the main body 21, and the second end cover 23 can he disposed to be detachably connected to the second end of the main body 21,

The housing 20 also can include first seals 25, and the first seals 25 can be disposed at the first through hole 221 of the first end cover 22 and the second through hole 231 of the second end cover 23. The housing 20 can include a second seal 26, and the second seal 26 can be disposed at an opening of the first end of the, main body 21 of the housing 20. Alternatively, the second seal 26 can be disposed at an opening of the second end of the main body 21 of the housing 20.

The housing 20 can include a first fixing member 27 and a second fixing member 28. The first fixing member 27 can be connected to the first end cover 22, and the first fixing member 27 can be provided with at least one third through hole 271 corresponding to the first through hole 221. The second fixing member 28 can be connected to the second end cover 23, and the second fixing member 28 can be provided with at least one fourth through hole 281 corresponding to the second through hole 231. In this way, the heating assembly 10 can pass through the third through hole 271 and the fourth through hole 281. The third through hole 271 and the fourth through hole 281 herein can be round.

The first seals 25 can be disposed between the first end cover 22 and the first fixing member 27, and between the second end cover 23 and the second fixing member 28. In addition, the flange 132 may be sandwiched between the first seal 25 at the second end of the main body 21 and the second fixing member 28.

The housing 20 can also include at least one partition plate 50, and the at least one partition plate 50 can be disposed in the cavity of the main body 21 in the longitudinal direction of the tubular cavity. The length of the partition plate 50 herein can be less than that of the tubular cavity, two opposite first end portions of the partition plate 50 can be connected to two opposite first side walls of the main body 21, at least one of two opposite second end portions of the partition plate 50 can be connected to at least one of the first end cover 22 and the second end cover 23, and the sleeve 131 can be disposed on two sides of the at least one partition plate 50.

### Second Embodiment

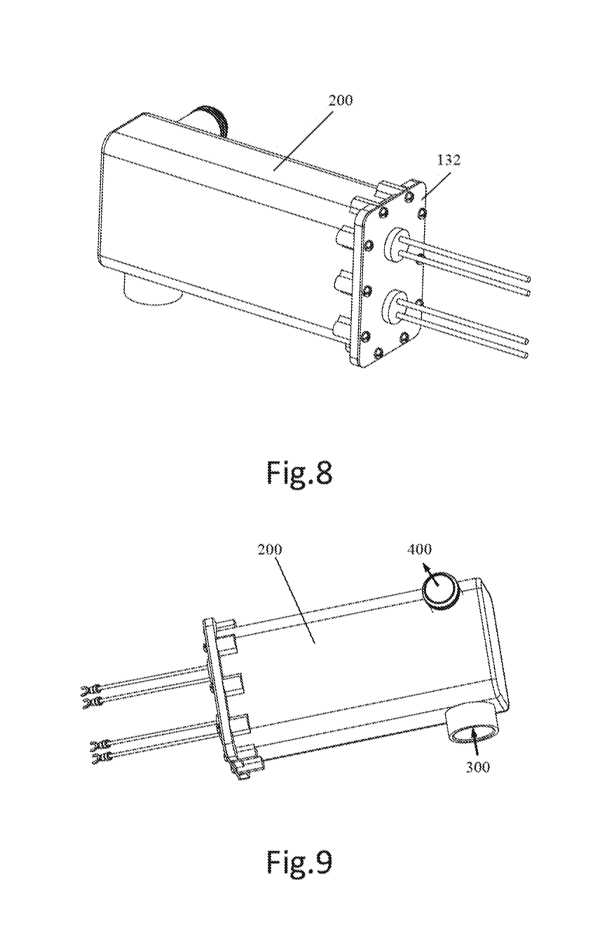

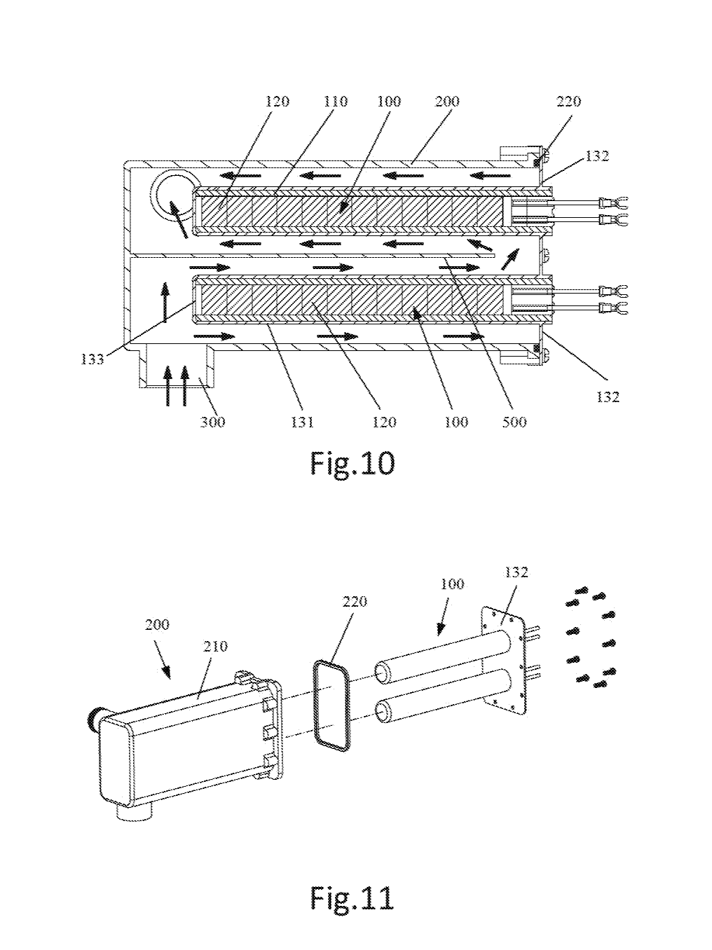

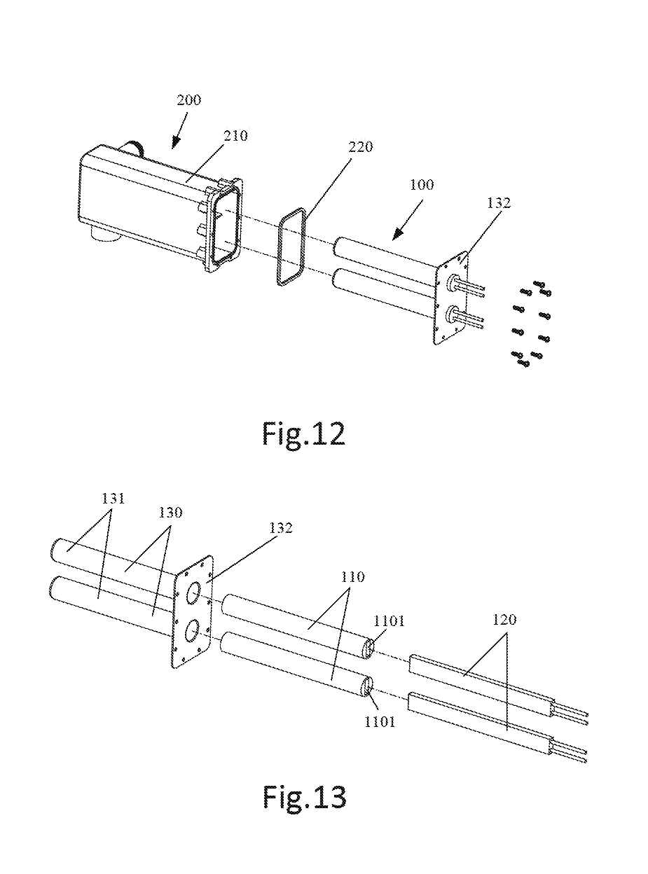

FIG. 8 is a first overall structural schematic view of a second embodiment of a PTC liquid heater of the present invention. FIG. 9 is a second overall structural schematic view of the second embodiment of the PTC liquid heater of the present invention. FIG. 10 is a sectional view of the second embodiment of the PTC liquid heater of the present invention, which is taken in the longitudinal direction. FIG. 11 is a first exploded view of the second embodiment of the PTC liquid heater of the present invention. FIG. 12 is a second exploded view of the second embodiment of the FTC liquid heater of the present invention. FIG. 13 is an exploded schematic view of a heating assembly in the second embodiment of the PTC liquid heater of the present invention.

As shown in FIGS. 8-13, the present invention discloses a PTC liquid heater, which can include a heating assembly 100 and a housing 200. The heating assembly 100 can include a heat conductor 110, a PTC heat generation assembly 120 and a sheath 130, at least one accommodating cavity 1101 can be disposed in the heat conductor 110, the PTC heat generation assembly 120 can be at least partially disposed in the at least one accommodating cavity 1101, and the sheath 130 can be provided with a cavity for accommodating the heat conductor 110 and the PTC heat generation assembly 120. In addition, a water inlet 300 and a water outlet 400 can be disposed on the housing 200.

The heat conductor 110 can be in the shape of a cylinder, and the at least one accommodating cavity 1101 can be disposed in the heat conductor 110 in an axial direction of the cylinder.

The sheath 130 can include a penetrating sleeve 131, and the heat conductor 110 and the PTC heat generation assembly 120 can be disposed in the sleeve 131 such that an inner surface of the sleeve 131 abuts against an outer surface of a side wall of the heat conductor 110. The sheath 130 can also include a sleeve end cover 133, and the sleeve end cover 133 can be disposed at one end of the sleeve 131, such that an edge of the sleeve end cover 133 can be connected to an edge of an end portion of the sleeve 131. The sheath 130 can also include a flange 132, the flange 132 can be connected to an outer surface of one end of the sleeve 131 and can extend outwardly. The sleeve 131 herein may be a straight, round tube, and the material of the sleeve 131 and the sleeve end cover 133 can be made of corrosion-resistant heat-conducting material, such as stainless steel or stainless iron.

The housing 200 can include a main body 210, the main body 210 in this embodiment can be provided with a box-shaped cavity and an opening, and a water inlet 300 and a water outlet 400 can be disposed on the main body 210. The heating assembly 100 can be connected to the end portion of the opening of the main body 210, and the heating assembly 100 can be at least partially disposed in the cavity of the main body 210.

The flange 132 herein can be connected to the end portion of the opening of the main body 210.

The housing 200 can also include a second seal 220, and the second seal 220 can be disposed between the surface on one side of the flange 132 and the end face of the opening of the main body 210.

The housing 200 can also include at least one partition plate 500, and the at least one partition plate 500 can be disposed in the cavity of the main body 210 in the longitudinal direction of the tubular cavity. The length of the partition plate 500 herein can be less than that of the tubular cavity, two opposite first end portions of the partition plate 500 can be connected to two opposite first side walls of the main body 210, at least one of two opposite second end portions of the partition plate 500 is connected to the first end cover 220, and the sleeve 131 can be disposed on two sides of the at least one partition plate 500.

### Third Embodiment

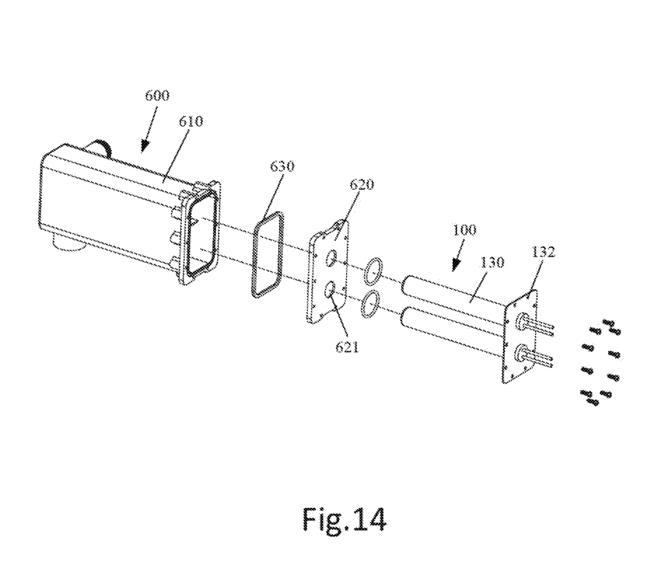

FIG. 14 is an exploded view of the third embodiment of the PTC heater of the present invention.

As shown in FIG. 14, the present invention also discloses a yet further PTC liquid heater, the structure of which is substantially the same as that of the second embodiment, except that the housing 600 can include a main body 610 and a first end cover 620. The main body 610 can be provided with a box-shaped cavity and an opening, and a water inlet and a water outlet CM he disposed on the main body 610. The first end cover 620 can be connected to the opening portion of the main body 610, and the first end cover 620 can be connected to the heating assembly 100. The heating assembly 100 can at least partially pass through the housing 600. The heating assembly 100 can at least partially be disposed in the cavity of the main body 610.

The sheath 130 of the heating assembly 100 can be connected to the first end cover 620. The flange 132 of the sheath 130 can be connected to the first end cover 620. The first end cover 620 can be provided with a first through hole 621, and the heating assembly 100 can pass through the first through hole 621. The flange 132 of the sheath 130 can be connected to the end portion of the opening of the main body 610.

The housing 600 can also include a second seal 630, and the second seal 630 can be disposed between the end portion of the opening of the main body 610 and the first end cover 620.

In a particular embodiment, a sealing ring may also be disposed between the flange 132 of the sheath 130 and the first end cover 620 at the first through hole 621 of the first end cover 620.

Of course, the housings in the first to third embodiments described above may be made of plastic.

The PTC heat generation assembly 12 in the above embodiments can include a group of heat generation ceramic sheets, two electrode sheets may be disposed on two sides of the group of heat generation ceramic sheets, multiple layers of insulating films are wound around the outer sides of the group of heat generation ceramic sheets and the two electrode sheets, and the outermost layer may be an aluminum profile envelope; its the actual implementation process, in order to enhance the insulating properties of the PTC heat generation assembly 12, a ceramic insulating plate may be disposed on the outer sides of the group of heat generation ceramic sheets and the two electrode sheets or between the multiple layers of insulating films.

The PTC heating generation 12 can include a PTC heating element, a first electrode, a second electrode, a first protection layer, a second protection layer, a first interlayer, and a second interlayer. The PTC heating element has a first side and a second side. The first electrode and the second electrode can be positioned on the first side of the PTC heating element and the second side of the PTC heating element respectively. The first insulating interlayer can be located between the first protection layer and the first electrode. The second insulating interlayer can be located between the second protection layer and the second electrode. The first protection layer and the second protection layer can have a greater hardness in comparison with the first and second insulating interlayer.

Moreover, the PTC heating generation 12 can further include a heat conductive housing. The first interlayer and second insulating interlayer are placed into the heat conductive housing. A first side wall and a second side wall of the heat conductive housing are inwardly curved.

In summary, the PTC liquid heater of the present invention has a better corrosion resistance, and can greatly extend the service life of the liquid PTC heater and prevent electric leakage accidents. The PTC liquid heater has a simple structure and low costs, and is convenient to assemble, especially in that the water pipes can be replaced, facilitating future maintenance.

The foregoing is merely illustrative of the principles of this invention and various modifications can be made by those skilled in the art without departing from the scope and spirit of the invention. The foregoing embodiments may be implemented individually or in any combination. However, these alterations and modifications all fall within the scope of protection of the present invention.

What is claimed is:

1. A PTC liquid heater, comprising:
a heating assembly, comprising:
a heat conductor comprising at least one accommodating cavity,
a PTC heat generation assembly disposed in the at least one accommodating cavity,
a sheath comprising a cavity for accommodating the heat conductor and the PTC heat generation assembly, and
a housing comprising a water inlet and a water outlet,
wherein the heating assembly is at least partially inserted in the housing.

2. The PTC liquid heater of claim 1, wherein the heat conductor is configured in a cylindrical shape, and the at least one accommodating cavity is configures in an axial direction of the heat conductor.

3. The PTC liquid heater of claim 1, wherein the sheath comprises a penetrating sleeve, the heat conductor and the PTC heat generation assembly are disposed in the sleeve;
wherein an inner surface of the sleeve abuts against art outer surface of a side wall of the heat conductor.

4. The PTC liquid heater of claim 3, wherein the sheath further comprises:
a sleeve end cover disposed at one end of the sleeve, an edge of the sleeve end cover being connected to an end edge of the sleeve.

5. The PTC liquid heater of claim 3, wherein the sheath further comprises:
a flange connected to an outer surface of one end of the sleeve and extending outwardly.

6. The PTC liquid heater of claim 3, wherein the sleeve is configured as a straight, round tube.

7. The PTC liquid heater of claim 4, wherein the sleeve and the sleeve end cover are made of corrosion-resistant heat-conducting material.

8. The PTC liquid heater of claim wherein the housing comprises:
a main body comprising a tubular cavity, allowing a fluid to flow through the tubular cavity;
a first end cover connected to a first end of the main body, at least one first through hole is arranged on the first end cover, and
a second end cover connected to a second end of the main comprising at least one second through hole is arranged on the second end cover;
wherein the heating assembly is inserted in the first and second through holes.

9. The PTC liquid heater of claim 8, wherein the first end cover is detachably connected to the first end of the main body, and the second end cover is detachably connected to the second end of the main body.

10. The PTC liquid heater of claim 8, wherein the first end cover is integrally formed with the main body, and the second end cover is detachably connected to the second end of the main body.

11. The PTC liquid heater of claim 8, wherein the first and second through holes are configured in round shape.

12. The PTC liquid heater of claim 8, wherein the housing further comprises:
first seals disposed at the first through hole of the first end cover and the second through hole of the second end cover, respectively.

13. The PTC liquid heater of claim 8, wherein the housing further comprises a second seal disposed at an opening of the first end of the main body it the housing.

14. The PTC liquid heater of claim 8, wherein the housing further comprises:
a second seal disposed at an opening of the second end of the main body of the housing.

15. The PTC liquid heater of claim 12, wherein the housing further comprises:
a first fixing member connected to the first end cover, comprising at least one third through hole is arranged on the first fixing member, and
a second fixing member connected to the second end cover, comprising at least one fourth through hole is arranged on the second fixing member;
wherein the sleeves of the heating assembly are passed through the third through hole and fourth through hole.

16. The PTC liquid heater of claim 15, wherein the first seals are disposed between the first end cover and the first fixing member, and disposed between the second end cover and the second fixing member, respectively.

17. The PTC liquid heater of claim 15, wherein the third through hole and fourth through hole are configured in round shape.

18. The PTC liquid heater of claim 15, wherein the flange of the sheath of the heating assembly is sandwiched between the first seal at the second end of the main body of the housing and the second fixing member.

19. The PTC liquid heater of claim 8, wherein the housing further comprises:
at least one partition plate disposed in the tubular cavity in the longitudinal direction, two opposite first ends of the partition plate being connected to two opposite first side walls of the main body, and at least one of two opposite second ends of the partition plate being connected to at least one of the first end cover and second end cover the sleeves being disposed on two sides of the partition plate, the length of the partition plate being less than that of the tubular cavity.

20. The PTC liquid heater of claim 8, at least one partition plate disposed in the tubular cavity in the longitudinal direction, two opposite first ends of the partition plate being connected to two opposite first side walls of the main body, two opposite second ends of the partition plate being connected to the first cover and second end cover, and at least one fifth through hole is arranged on the partition plate

21. The PTC liquid heater of claim 8, wherein the water inlet and the water outlet are disposed on the main portion of the housing respectively.

22. The PTC liquid heater of claim 1, wherein the housing comprises:
a main body comprising a box-shaped cavity and an opening, the main body comprising a water inlet and a water outlet;
a first end cover connected to the opening of the main body, and a first end cover connected to the heating assembly;
wherein the heating assembly is at least partially inserted in the cavity of the main body.

23. The PTC liquid heater of claim 22, wherein the sheath of the heating assembly is connected to the first end cover.

24. The PTC liquid heater of claim 23, wherein the flange of the sheath is connected to the first end cover.

25. The PTC liquid heater of claim 23, wherein the first end cover comprises a first through hole, the heating assembly is passed through the first through hole.

26. The PTC liquid heater of claim 23, the housing further comprising a second seal disposed between the end portion of the opening of the main body and the first end cover.

27. The PTC liquid heater of claim 1, wherein comprises:
a main body comprising a box-shaped cavity and an opening, the main body comprising a water inlet and a water outlet;
the heating assembly connected to the opening of the main body;
wherein the heating assembly is at least partially inserted in the cavity of the main body.

28. The PTC liquid heater of claim 27, wherein the flange of the sheath of the heating assembly is connected to the opening of the main body.

29. The PTC liquid heater of claim 28, wherein the housing further comprises a second seal disposed between a surface of one side of the flange of the sheath and the opening of the main body.

30. The PTC liquid heater of claim 1, wherein the housing is made of plastic.
